(19) United States
(12) Patent Application Publication
(10) Pub. No.: US 2024/0100757 A1
(43) Pub. Date: Mar. 28, 2024

(54) BONDING HIGHLY-FLUORINATED PLASTICS TO ELASTOMERS USING SILANE-BASED PRIMERS

(71) Applicant: 3M INNOVATIVE PROPERTIES COMPANY, St. Paul, MN (US)

(72) Inventors: Tho Q. Nguyen, Bloomington, MN (US); Craig R. Hoff, Corcoran, MN (US); Naiyong Jing, St. Paul, MN (US)

(21) Appl. No.: 17/754,832

(22) PCT Filed: Nov. 2, 2020
(86) PCT No.: PCT/IB2020/060279

§ 371 Date: Apr. 13, 2022

Related U.S. Application Data
(60) Provisional application No. 62/932,140, filed on Nov. 7, 2019.

(51) Int. Cl. B29C 48/00; B29C 35/08; B29C 48/09; B29C 48/21; B29D 23/00; B32B 1/08; B32B 7/12; B32B 25/08; B32B 25/16; B32B 27/30; B32B 27/32; C09J 5/00; C09J 183/08; F16L 11/04

(52) U.S. Cl. CPC B29C 48/022; B29C 35/08; B29C 48/09; B29C 48/21; B29D 23/00; B32B 1/08; B32B 7/12; B32B 25/08; B32B 25/16; B32B 27/304; B32B 27/322; C09J 5/00; C09J 183/08; F16L 11/04; B29K 2027/12; B29K 2995/0098; B32B 2250/02; B32B 2250/24; B32B 2255/10; B32B 2255/24; B32B 2307/748; B32B 2597/00

(57) ABSTRACT

Methods of bonding highly-fluorinated thermoplastics to elastomers are described. The methods include apply primers comprising at least one aromatic silane and at least one amino-silane to an uncured elastomer and irradiating the primer with actinic radiation before or after applying the highly-fluorinated thermoplastics. The elastomer may then be cured to provide articles having good adhesion between the highly-fluorinated thermoplastic and the cured elastomer.

### FIELD

The present disclosure relates to methods of using silane-based primer systems to bond highly-fluorinated plastics, e.g., perfluoroplastics, to elastomers, including fluoroelastomers. Bonded articles prepared using such methods are also described.

### SUMMARY

Briefly, in one aspect, the present disclosure provides methods of forming a multilayer article comprising: (a) applying a primer comprising (i) an aromatic silane and (ii) an amino-silane onto a composition comprising an uncured elastomer; (b) applying a highly-fluorinated thermoplastic onto the primer; (c) irradiating the primer with actinic radiation; and (d) forming a bond between the highly-fluorinated thermoplastic and the composition. In some embodiments, the methods further comprise, after irradiating the primer with actinic radiation, (e) curing the uncured elastomer to form a cured elastomer.

In another aspect, the present disclosure provides articles made by the methods of the present disclosure, e.g., hoses. In some embodiments, the adhesive force between the highly-fluorinated thermoplastic and the cured elastomer, as measured according to the Interlayer Adhesion Test, is at least 5 N/cm.

The details of one or more embodiments of the invention are also set forth in the description below. Other features, objects, and advantages of the invention will be apparent from the description and from the claims.

### BRIEF DESCRIPTION OF THE DRAWINGS

FIG. 1 illustrates methods according to some embodiments of the present disclosure.

FIG. 2 illustrates alternative methods according to some embodiments of the present disclosure.

FIG. 3 illustrates an exemplary article prepared by methods according to the present disclosure.

### DETAILED DESCRIPTION

Fluorine-containing polymers (also known as “fluoropolymers”) include, for example, fluoroelastomers and fluorothermoplastics (also known as “fluoroplastics”). Fluoropolymers generally have high thermal stability and are useful at high temperatures. They may also exhibit extreme toughness and flexibility at very low temperatures. Many of these fluoropolymers, particularly highly-fluorinated (e.g., perfluorinated polymers) are generally chemically resistant and may be almost totally insoluble in a wide variety of solvents.

Fluoropolymers are used in a wide variety of industrial applications. Some of these applications require combinations of the beneficial characteristics of fluoropolymers, such as good chemical resistance, high temperature stability, and low temperature flexibility. Such applications may use multilayer constructions. For example, in some applications a highly-fluorinated polymer may be combined with an elastomer. Such constructions find utility in, for example, fuel line hoses, turbo charger hoses, and containers, hoses, gaskets and seals for chemical processing.

Adhesion between the layers of a multi-layered article may need to meet various performance standards depending on the use of the finished article. However, it is often difficult to establish high bond strengths when one of the layers is a fluoropolymer, in part, because of the non-adhesive qualities of fluoropolymers. Bonding can be particularly challenging when fluoropolymer is highly-fluorinated or perfluorinated.

Various methods have been proposed to address this problem. One approach is to use an adhesive layer or tie layer between the fluoropolymer layer and the second layer. Surface treatments for the fluoropolymer layer, including the use of powerful reducing agents or corona discharge, have also been employed to enhance adhesion.

Despite these and other approaches, obtaining good adhesion between a highly-fluorinated thermoplastic (e.g., a perfluoroplastic) and an elastomer remains challenging. Surprisingly, the present inventors have discovered that the methods used to bond such materials can be critical to achieving good adhesion.

Generally, the present disclosure relates to multilayer articles comprising at least one highly-fluorinated thermoplastic bonded to an elastomer with a bonding composition (also referred to as a primer). Although the form of such articles is not particularly limited and may include sheets and molded articles, such constructions may be particularly beneficial for use in hoses, e.g., fuel line and turbo charger hoses.

As used herein, “highly-fluorinated” means that at least 90% of the total number of halogen and hydrogen atoms in the polymer are fluorine atoms. In some embodiments, at least 95%, or even at least 99%, of the total number of halogen and hydrogen atoms in the polymer are fluorine atoms. For example, in some embodiments, the polymer is “fully-fluorinated” which means the repeating monomer units of the highly-fluorinated thermoplastic do not comprise any carbon-hydrogen bonds; however the fluoropolymer may comprise some carbon-hydrogen bonds that originate from the methods and materials used in polymerization, e.g., the emulsifier, the initiator system, and/or the chain transfer agent, if used. In some embodiments, the highly-fluorinated thermoplastic may be a perfluoroplastic.

Generally, the selection of the highly-fluorinated thermoplastic is not limited. Exemplary highly-fluorinated thermoplastics include copolymers of tetrafluoroethylene (TFE) and hexafluoropropylene (HFP), commonly referred to as FEP; copolymers of TFE and fluorinated vinyl ethers, e.g., copolymers of TFE and perfluoropropyl vinyl ether, commonly referred to as PFA; copolymers of TFE, HFP, low amounts of vinylidene fluoride (VF2, also referred to as VDF), and, optionally, perfluorinated vinyl and allyl ethers (e.g., perfluoromethylvinyl ether (PMVE) and perfluoro(propylvinylether (PPVE), including polymers available under the trade name THV from 3M Company. Other monomers suitable for use in preparing highly-fluorinated thermoplastics include chlorotrifluoroethylene, 3-chloropentafluoropropene, perfluorinated vinyl and allyl ethers, and perfluoroalkoxy vinyl and allyl ethers. In some embodiments, small amounts of hydrocarbon dienes such as ethylene and propylene may also be present, provided that at least 90% (e.g., at least 95% or even at least 99%) of the total number of halogen and hydrogen atoms in the polymer are fluorine atoms.

Suitable elastomers include both fluorinated elastomers (“fluoroelastomers”) and non-fluorinated elastomers. Fluorinated elastomers include partially-fluorinated elastomers (“FKM” ASTM D1418-17, also referred to as “FPM” under the ISO/DIN 1629 standard), perfluorinated elastomers (“FFKM”), and fluorinated ethylene/propylene rubbers (TFE/P referred to as “FEPM”). Generally, FKM elastomers are copolymers that include vinylidene fluoride repeating units, e.g., copolymers of HFP and VF2; terpolymers such as TFE/HFP/VF2; TFE/VF2/propylene; and TFE/VF2/PMVE. Generally, FFKM elastomers are copolymers of TFE and perfluorinated ethers including perfluoroalkyl vinyl ethers, perfluoroalkoxy vinyl ethers, perfluoroalkyl allyl ethers, and perfluoroalkoxy allyl ethers.

Exemplary non-fluorinated elastomers include acrylonitrile-butadiene rubber (NBR), butadiene rubber, chlorinated and chlorosulfonated polyethylene, chloroprene rubber, ethylene-propylene monomer (EPM) rubber, ethylene-propylene-diene monomer (EPDM) rubber, epichlorohydrin (ECO) rubber, polyisobutylene rubber, polyisoprene rubber, polysulfide rubber, polyurethane, silicone rubber, blends of polyvinyl chloride and NBR, styrene butadiene (SBR) rubber, ethylene-acrylate copolymer rubber, and ethylene vinyl acetate rubber.

Bonding compositions comprising a light-absorbing compound and an electron donor have been used to bond a fluoropolymer to a variety of substrates. For example, U.S. Pat. No. 6,630,047 describes using bonding compositions comprising light-absorbing compounds and an electron donor to adhere fluoropolymers to various substrates. A wide variety of suitable light absorbing compounds are described including those that have a moiety capable of being excited by actinic radiation such as an aromatic moiety. A wide variety of electron donors are also described, including amines such as primary amines and amino-substituted organosilanes. Similarly, U.S. Pat. No. 6,685,793 describes the use of bonding compositions comprising a light-absorbing electron donor to adhere a fluoropolymer to a substrate. Suitable light-absorbing electron donors include fluorinated amines and fluorinated anilines. The bonding compositions may also include an aliphatic or aromatic amine, including amino-substituted organosilanes.

The bonding compositions of the present disclosure comprise (i) an aromatic silane and (ii) an amino-silane.

Aromatic silanes suitable for use in the present disclosure include those according to Formula (I):

Ar-L-Si—Y₃ (I),

where Ar is an aromatic group and L is a covalent bond or a divalent linking group. In some embodiments, each Y is independently selected from —OH and —OR¹, where R¹ is an alkyl group, for example a C1 to C6, linear or branched alkyl group. In some embodiments, provided that at least one Y is —OH or —OR¹, one or two of the Y-groups may be a C1 to C4 alkyl group. In some embodiments, Ar is a benzyl group, optionally a substituted benzyl group such as a phenyl group. In some embodiments, L is a straight chain alkene having, e.g., 1 to 12 carbon atoms, or a cycloalkene having, e.g., 3 to 8 carbon atoms. In some embodiments, the linking group comprises a heteroatom (e.g., oxygen, phosphorous, sulfur or nitrogen). In some embodiments, the linking group comprises a nitrogen atom and the aromatic silane is an aromatic aminosilane. In some embodiments, the aromatic aminosilane is one according to Formula (II):

Ar—N(X)—Si—Y₃ (II),

where Ar is an aromatic group (e.g., a phenyl group). In some embodiments, X is a hydrogen and the compound comprises a secondary amine. In some embodiments, X is an organic group, optionally containing a heteroatom (e.g., oxygen), and the compound comprises a tertiary amine. In some embodiments, X is a linear or branched alkyl group having, e.g., 1 to 8 carbon atoms, e.g., 1 to 4 carbon atoms. In some embodiments, each Y is independently selected from —OH and —OR¹, where R¹ is an alkyl group, for example a C1 to C6, linear or branched alkyl group. In some embodiments, provided that at least one Y is —OH or —OR¹, one or two of the Y-groups may be a C1 to C4 alkyl group.

Exemplary aromatic silanes suitable for use in some embodiments of the present disclosure include N-phenylaminoalkyltrialkyl silanes and N-phenylaminoalkyltrialkoxy silanes, e.g., N-phenylaminomethyltriethoxy silane.

Aminosilanes suitable for use in the bonding compositions of the present disclosure include those according to Formula (III):

R²R³N-Q-SiZ₃ (III),

where: each of R² and R³ are, independently, H, a C1 to C12 alkenyl, alkenyl, or alkynyl group or an aromatic group, and Q is a divalent linking group. In some embodiments, Q is a divalent straight chain C1-12 alkylene, C3-8 cycloalkylene, 3-8 membered ring heterocycloalkylene, C1-12 alkenylene, C3-8 cycloalkenylene, 3-8 membered ring heterocycloalkenylene, arylene, or heteroarylene. In some embodiments, Q is optionally substituted with C1-4 alkyl, C2-4 alkenyl, C2-4 alkynyl, C1-4 alkoxy, hydroxyl, halo, carboxyl, amino, nitro, cyano, C3-6 cycloalkyl, 3-6 membered heterocycloalkyl, monocyclic aryl, 5-6 membered ring heteroaryl, C1-4 alkylcarbonyloxy, C1-4 alkyloxycarbonyl, C1-4 alkylcarbonyl, formyl, C1-4 alkylcarbonylamino, or C1-4 aminocarbonyl.

In Formula (III), each Z is independently selected from a halogen, an alkyl group (e.g., a C1 to C8 alkyl group), an alkoxy group (e.g., a C1 to C8 alkoxy group), an alkycarbonyloxy (e.g., a C1 to C8 alkycarbonyloxy group), or an amino group.

Exemplary amino silanes suitable for use in some embodiments of the present disclosure include (aminoalkyl)trialkyl silanes, (aminoalkyl)trialkoxy silanes, (aminoalkyl)dialkylalkoxy silanes and (aminoalkyl)dialkoxyalkyl silanes. In some embodiments, (3-Aminopropyl)trimethoxy silane may be used. In some embodiments, the linking group, Q, comprises one or more amino groups. For example, in some embodiments, suitable amino silanes include N-(2-Aminoethyl)-3-aminopropyltrimethoxysilane and 3-[2-(2-Aminoethylamino)ethylamino]propyltrimethoxysilane, and the like.

Generally, coatings containing the bonding compositions are prepared by combining at least one aromatic silane, e.g., an aromatic amino silane, with at least one amino silane that is different from the aromatic silane in a solvent. In some embodiments, the coatings comprise 1 to 10, e.g., 2 to 10, or even 3 to 6 wt. % of the aromatic silane, based on the total weight of the coating composition, including the solvent(s). In some embodiments, the coating comprises 0.05 to 5, e.g., 0.1 to 5, 0.1 to 3, or even 0.1 to 1 wt. % of the amino silane, based on the total weight of the coating composition, including the solvent(s). The coating composition may include other materials such a dyes, drying aides, coating aides and the like.

These components can be combined with any suitable solvent. Suitable solvents are known in the art and may depend on the specific silanes selected as well as the substrate to which the primer will be applied. Suitable solvents include those comprising at least one organic solvent such as one or more alcohols (e.g., methanol, ethanol and propanol), and/or fluorinated solvents. In some embodiments, the solvent may comprise water. Although not particularly limited, the coating composition may comprise up to 98 wt. %, e.g. up to 96 wt. % or up to 94 wt. % solvent(s). In some embodiments, the coating composition comprises at least 80 wt. %, e.g., at least 90 wt. % or even at least 95 wt. % of the solvent(s).

In addition to the selection of the components used in the bonding composition, the present inventors discovered that, when attempting to bond highly-fluorinated thermoplastics to elastomers, the methods used to form the bond play a critical role in achieving the desired bond strength. This effect is illustrated by the following examples.

### Examples

TABLE 1
Summary of materials used in the preparation of the examples.

| Name | Description | Trade Name and Source |
|---|---|---|
| FTP-1 | TFE/HFP | DYNEON FEP 6309 |
| | (fully-fluorinated thermoplastic) | Flex, 3M Company |
| FTP-2 | TFE/HFP/VF2/PPVE | DYNEON THV-815, |
| | (highly-fluorinated thermoplastic, | 3M Company |
| | 94% F) | |
| ELAST-1 | TFE/HFP/VF2 | DYNEON FE 5830Q, |
| | (fluorinated elastomer, 70.5% F) | 3M Company |
| ELAST-2 | Acrylonitrile butadiene (NBR) | KRYNAC 3345F, |
| | (non-fluorinated elastomer) | RD Abbot |
| Phenyl | N-phenylaminomethyltriethoxy | Aldrich |
| Silane | silane | |
| APMS | (3-Aminopropyl)trimethoxy silane | Aldrich |
| CaO | Calcium oxide | Hallstar |
| Ca(OH)2 | Calcium hydroxide | Hallstar |
| MgO | Magnesium oxide | ELASTOMAG 170, |
| | | Akrochem |
| CB-1 | Carbon black | N-990, Cabot |
| CB-2 | Carbon black | N-762, Cabot |
| DBU | 1,8-diazabicyclo[5.4.0] | Aldrich |
| | undec-7-ene | |
| Wax | Canauba wax | |
| Plast-1 | Plasticizer | Plasthall A126, Hallstar |
| POx | Dicumyl peroxide | Di-cup 40A, Arkema |

Primer-A. Primer-A was prepared as a coating composition by mixing 2.01 wt. % of APMS and 0.67 wt. % Phenyl Silane in methanol.

Fluorinated Elastomer (FE-1). FE-1 was prepared by compounding the materials listed in Table 2A.

TABLE 2A
Composition of curable fluoroelastomers
(amounts shown in parts by weight (pbw)).

| Component | FE-1 |
|---|---|
| ELAST-1 | 100 |
| N-990 | 30 |
| CaO | 6 |
| Ca(OH)2 | 3 |
| MgO | 3 |
| Wax | 1 |

Non-Fluorinated Elastomer (NFE-1). NFE-1 was prepared by compounding the materials listed in Table 2B.

TABLE 2B
Composition of curable non-fluorinated
elastomers (amounts shown in pbw).

| Component | NFE-1 |
|---|---|
| ELAST-2 | 100 |
| N-762 | 60 |
| CaO | 5 |
| Ca(OH)2 | 5 |
| Plast-1 | 5 |
| POx | 3.5 |
| Stearic acid | 2 |
| DBU | 0.7 |

Sheets of uncured elastomer were prepared by pressing the desired elastomer composition (e.g., FE-1 or NFE-1) between two release liners for five minutes at 93° C. (200° F.) at a thickness of 2 mm (0.08 inch).

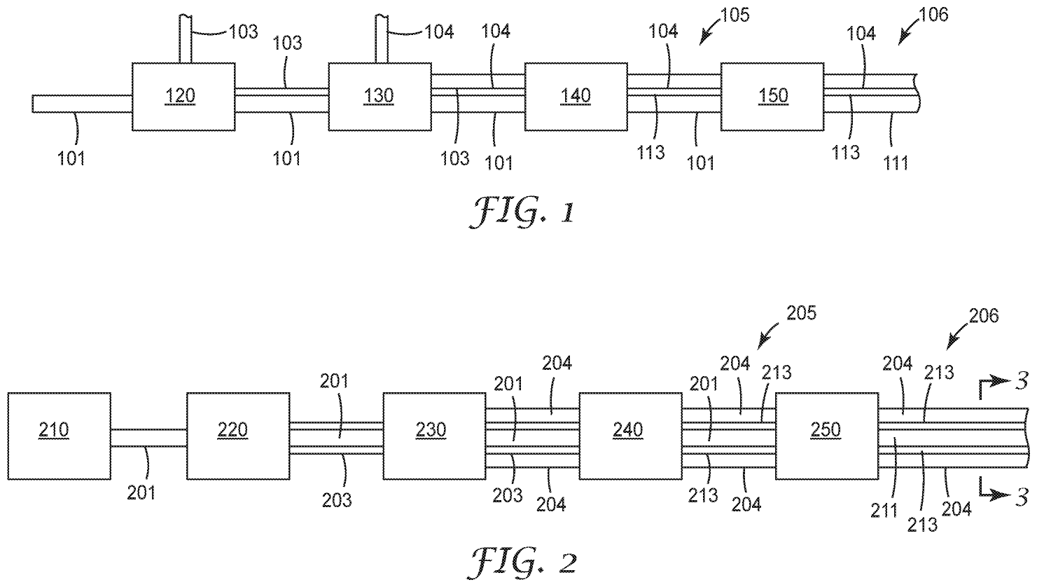

Examples 1-3 were prepared according to one exemplary method of the present invention as illustrated in FIG. 1. Generally, primer (103) is applied as a coating composition to uncured elastomer (101) and dried to remove the solvent (Step 120). Next, highly-fluorinated thermoplastic (104) is applied to the primer-coated uncured elastomer (Step 130). The primer is exposed to actinic radiation through the highly-fluorinated thermoplastic and/or the elastomer (Step 140) to form intermediate article (105) with irradiated primer (113) at the interface between uncured elastomer (101) and highly-fluorinated thermoplastic (104). In some embodiments, the uncured elastomer in this laminated structure is then cured (Step 150) to form article (106) comprising cured elastomer (111) bonded to highly-fluorinated thermoplastic (104) by irradiated primer (113). Optionally, the construction can be formed (e.g., molded) into a desired shape prior to or after curing the elastomer.

In some embodiments, the primer may be exposed to actinic radiation through the elastomer, or through both the elastomer and the fluoroplastic. In some embodiments, the primer may be exposed to the actinic radiation before the highly-fluorinated thermoplastic is applied, either directly and/or through the elastomer.

Actinic radiation is electromagnetic radiation having a wavelength capable of affecting bonding between the highly-fluorinated thermoplastic and the elastomer in the presence of the bonding composition (primer). The wavelength and intensity of the actinic radiation will depend, in part, on the materials selected including aromatic silane. In some embodiments, the actinic radiation may have a wave length between 190 nm and 700 nm, e.g., between 200 and 400 nm, between 205 and 320, between 210 and 290 nm, or even between 240 nm and 260 nm. Suitable equipment and procedures for delivering the actinic radiation are known in the art.

The elastomer can be cured using known means selected for the particular elastomer used. In some embodiments, the elastomer is thermally cured in, e.g., an oven or autoclave.

Example 1 (EX-1). An uncured sheet of FE-1 was coated with Primer A and dried. A sheet of FTP-1 (approximately 7.6 cm×7.6 cm×0.25 mm thick) was laminated on top of the primer-coated FE-1 sheet between two release liners, pressed for five minutes at 93° C., removed from the press and allowed to cool. The laminated construction was UV irradiated with a FUSION 500-watt H-bulb for 60 seconds at 35% intensity. After irradiation, the laminate was placed in a steam autoclave for 35 minutes at minutes at 163° C. and 496 kPa to cure the elastomer. After cooling to room temperature, the laminate was tested for interlayer adhesion.

Example EX-2 was prepared in the same manner as EX-1, except that highly-fluorinated thermoplastic FTP-2 was used. Likewise, EX-3 was prepared in the same manner as EX-1, except that the elastomer was non-fluorinated elastomer NFE-1.

Comparative Examples CE-1 to CE-4 were prepared in a similar manner, except that the primer was applied to the highly-fluorinated thermoplastic sheet instead of the uncured elastomer, and the primer was irradiated prior to lamination.

Comparative Example 1 (CE-1). A sheet of FTP-1 (approximately 7.6 cm×7.6 cm×0.25 mm thick) was coated with Primer A and dried. The primer was UV irradiated with a FUSION 500-watt H-bulb for 60 seconds at 35% intensity. This primer-coated, highly-fluorinated thermoplastic sheet was laminated on top of an uncured sheet of fluoroelastomer FE-1 with the irradiated primer adjacent the uncured elastomer, placed between two release liners, pressed for five minutes at 93° C., removed from the press and allowed to cool. The laminate was then placed in a steam autoclave for 35 minutes at minutes at 163° C. and 496 kPa to cure the elastomer. After cooling to room temperature, the laminate was tested for interlayer adhesion.

Comparative Example CE-2 was prepared in the same manner as CE-1, except that highly-fluorinated thermoplastic FTP-2 was used.

Comparative Example CE-3 was prepared in the same manner as CE-1, except that primer-coated FTP-1 sheet was laminated on top of a cured sheet of FE-1 with the irradiated primer adjacent the cured elastomer, placed between two release liners, pressed for three minutes at 93° C., removed from the press and allowed to cool. No subsequent autoclave processing was performed as the elastomer was already cured.

Comparative Example CE-4 was prepared in the same manner as CE-3, except that highly-fluorinated thermoplastic FTP-2 was used.

Comparative Example CE-5 was prepared in a manner similar to EX-1, except that the primer was applied to a cured elastomer rather than an uncured elastomer. Specifically, a cured sheet of fluoroelastomer FE-1 was coated with Primer A and dried. A sheet of FTP-1 (approximately 7.6 cm×7.6 cm×0.25 mm thick) was laminated on top of the primer-coated cured FE-1 sheet between two release liners, pressed for three minutes at 93° C., removed from the press and allowed to cool. The laminated construction was UV irradiated with a FUSION 500-watt H-bulb for 60 seconds at 35% intensity. No subsequent autoclave processing was performed as the elastomer was already cured.

Comparative Example CE-6 was prepared in a manner similar to EX-1, except that the primer was applied to the highly-fluorinated thermoplastic sheet instead of the uncured elastomer. Like Example EX-1, the primer was not irradiated until after lamination. Specifically, a sheet of FTP-1 (approximately 7.6 cm×7.6 cm×0.25 mm thick) was coated with Primer A and dried. This primer-coated, highly-fluorinated thermoplastic sheet was laminated on top of an uncured sheet of fluoroelastomer FE-1 with the cured primer adjacent the uncured elastomer, placed between two release liners, pressed for five minutes at 93° C., removed from the press and allowed to cool. The laminated construction was UV irradiated with a FUSION 500-watt H-bulb for 60 seconds at 35% intensity. After irradiation, the laminate was placed in a steam autoclave for 35 minutes at minutes at 163° C. and 496 kPa to cure the elastomer. After cooling to room temperature, the laminate was tested for interlayer adhesion.

Interlayer Adhesion Test. The samples were evaluated for bonding by carrying out a 180 degree peel test at 30.5 cm/min (12.0 in/min) in a tensiometer from MTS Systems Corporation, Eden Prairie, Minn., following the ASTM D413-76, type A test procedure.

The samples were tested according to the Interlayer Adhesion test. The results are summarized in Table 3. In Table 3, “AF” indicates “adhesive failure” where the two layers separated. “CF” indicates “cohesive failure” where one of the layers split, which indicates superior performance compared to AF when the same or similar materials are used.

In some embodiments, the desired adhesive force between the highly-fluorinated thermoplastic and the cured elastomer, as measured according to the Interlayer Adhesion Test, is at least 5 N/cm, in some embodiments, at least 10 N/cm, at least 15 N/cm, or even at least 20 N/cm. When the failure mode is CF, the measured force indicates the minimum adhesive force between the layers, as below that value the layers did not separate, but above that force one of the layers split. Therefore, when the failure mode is CF, the adhesive force between the layers may be higher than the force reported in Table 3.

TABLE 3
Interlayer adhesion test results.

| Sample | EX-1 | EX-2 | EX-3 | CE-1 | CE-2 | CE-3 | CE-4 |
|---|---|---|---|---|---|---|---|
| Highly-Fluorinated | FTP-1 | FTP-2 | FTP-1 | FTP-1 | FTP-2 | FTP-1 | FTP-2 |
| Thermoplastic | | | | | | | |
| Elastomer | FE-1 | FE-1 | NFE-1 | FE-1 | FE-1 | FE-1 | FE-1 |
| Results | | | | | | | |
| Failure mode | CF | CF | CF | AF | AF | AF | AF |
| Force (N/cm) | 16 | 43 | 20 | 0 | 0 | 0 | 0 |

| | | | |
|---|---|---|---|
| Comments | Primer applied to uncured | Primer applied to | Primer applied to |
| | elastomer; | FTP, irradiated | FTP, irradiated |
| | irradiated after laminated to | before laminated to | before laminated |
| | FTP | uncured elastomer | to cured elastomer |

| Sample | CE-5 | CE-6 |
|---|---|---|
| Highly-Fluorinated | FTP-1 | FTP-1 |
| Thermoplastic | | |
| Elastomer | FE-1 | FE-1 |
| Results | | |
| Failure mode | AF | AF |
| Force (N/cm) | 0 | 0 |
| Comments | Primer applied to cured | Primer applied to FTP, |
| | elastomer, irradiated | irradiated after |
| | after lamination to FTP | lamination to uncured elastomer |

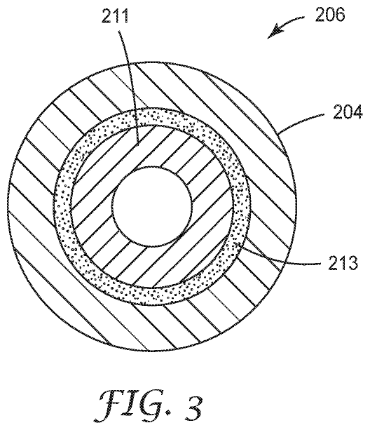

Another exemplary method of some embodiments of the present disclosure is illustrated in FIG. 2. Generally, uncured elastomer (201) is extruded or otherwise formed (Step 210) into a sheet, hose, or other desired structure (202). Primer (203) is applied to the uncured elastomer and dried to remove the solvent (Step 220). Next, highly-fluorinated thermoplastic (204) is applied to, e.g., extruded around, the primer-coated uncured elastomer (Step 230). The primer is exposed to actinic (e.g., UV) radiation through the highly-fluorinated thermoplastic (Step 240) to form intermediate article 205 with irradiated primer (213) at the interface between uncured elastomer (201) and highly-fluorinated thermoplastic (204). In some embodiments, the uncured elastomer in this multilayer structure is then cured (Step 250) to form cured article (206) comprising cured elastomer (211) bonded to highly-fluorinated thermoplastic (204) by the actinic radiation processed primer (213).

In some embodiments, the primer may be exposed to actinic radiation through the elastomer, or through both the elastomer and the fluoroplastic. In some embodiments, the primer may be exposed to the actinic radiation before the highly-fluorinated thermoplastic is applied, either directly and/or through the elastomer.

FIG. 3 illustrates a cross-section of cured article (206) taken at line 3-3 of FIG. 2, showing highly-fluorinated thermoplastic (204) bonded to cure elastomer (211) by irradiated primer (213). Although shown as a circular cross-section, the form of the article is not particularly limited. Although shown as a hollow tube, this is not required. In some embodiments, additional layers may be included, e.g., materials bonded to one or both of the uncoated surfaces of highly-fluorinated thermoplastic (204) or cured elastomer (211).

Example 5 (EX-5) was prepared according to this general process. A 6.4 mm cord of uncured fluoroelastomer FE-1 was extruded according to the conditions summarized in Table 4, coated with Primer A, and then extrusion coated with highly-fluorinated thermoplastic FTP-2. This multi-layer construction was cut into approximately 30 cm lengths, which were then irradiated with UV light with a FUSION 500-watt H-bulb for 60 seconds at 35% intensity. This construction was then placed in a steam autoclave for 35 minutes at 163° C. and 496 kPa.

The interlayer adhesion was tested resulting in cohesive failure, indicating a strong bond between the elastomer and the highly-fluorinated thermoplastic.

In the methods of the present disclosure, the bonding composition may be applied to the uncured elastomer using any known means. Exemplary methods include spray coating and roller coating.

Although the examples illustrate two-layer constructions, articles comprising more layers can also be produced. In some embodiments, additional layers of highly-fluorinated thermoplastics may be included, with or without additional primer layers. In some embodiments, additional layers of an elastomer, e.g., a fluoroelastomer may be included, again with or without additional primer layers. In some embodiments, the constructions of the present disclosure can be combined with, e.g., bonded to other substrates. Suitable additional substrates include, but are not limited to metals, polymers (e.g., plastics and elastomers), glasses, and ceramics.

In some embodiments, one or both of the highly-fluorinated layer and the elastomer layer can include any of a variety of additives know in the art to achieve desired additional properties such a color, and thermal or electrical conductivity or resistance, UV or light stability. Exemplary additives include, e.g., dyes, pigments, fillers, UV or light-stabilizers, and processing additives.

The methods of the present disclosure may be conducted as separate steps. In some embodiments, one or more of the steps may be part of single continuous process. For example, in some embodiments, the methods of the present disclosure can include a single line in which (b) a primer may be applied (e.g. spray-coated) to an uncured elastomer and, if necessary, dried; (c) a highly-fluorinated thermoplastic can be applied (e.g., extruded) onto the primer; and (d) the primer can be exposed to actinic radiation through one or both of the highly-fluorinated thermoplastic and the uncured fluoroelastomer. In some embodiments, this single process may also include (a) forming (e.g., extruding) the uncured fluoroelastomer prior to applying the primer. In some embodiments, this single process may also include (e) curing (e.g., thermally curing) the uncured fluoroelastomer.

1. A method of forming a multilayer article comprising:
(a) applying a primer comprising (i) an aromatic silane and (ii) an amino-silane onto a composition comprising an uncured elastomer;
(b) applying a highly-fluorinated thermoplastic onto the primer;
(c) irradiating the primer with actinic radiation; and
(d) forming a bond between the highly-fluorinated thermoplastic and the composition.

2. The method of claim 1, further comprising, after irradiating the primer with actinic radiation, (e) curing the uncured elastomer to form a cured elastomer.

3. The method of claim 2, wherein curing the uncured elastomer comprises thermally curing the uncured elastomer.

4. The method according to claim 1, wherein the primer is irradiated after the highly-fluorinated thermoplastic is applied onto the primer.

5. The method according to claim 1, wherein the primer is irradiated before the highly-fluorinated thermoplastic is applied onto the primer.

6. The method according to claim 1, wherein applying the highly-fluorinated thermoplastic onto the primer comprises extruding the highly-fluorinated thermoplastic.

7. The method according to claim 1, further comprising extruding the composition comprising the uncured elastomer prior to applying the primer.

8. The method according to claim 1, wherein the highly-fluorinated thermoplastic is a fully-fluorinated thermoplastic.

9. The method of claim 8, wherein the perfluoroplastic comprises at least one of a fluorinated ethylene propylene (FEP) and a perfluoroalkoxy alkane (PFA).

10. The method according to claim 1, wherein the highly-fluorinated thermoplastic comprises a copolymer comprising tetrafluoroethylene, hexafluoropropylene, and vinylidene fluoride.

11. The method according to claim 1, wherein the elastomer comprises a fluoroelastomer.

12. The method according to claim 1, wherein the elastomer comprises nitrile butadiene rubber.

13. The method according to claim 1, wherein the aromatic silane is an aromatic secondary amino-silane or an aromatic tertiary amino-silane.

14. The method of claim 13, wherein the aromatic silane comprises an N-phenylaminoalkyltrialkoxysilane.

15. The method according to claim 1, wherein the amino-silane is an (aminoalkyl) trialkoxy silane.

16. A multilayer article made by the method according to claim 2.

17. The multilayer article of claim 16, wherein an adhesive force between the highly-fluorinated thermoplastic and the cured elastomer, as measured according to the Interlayer Adhesion Test, is at least 5 N/cm.

18. The multilayer article of claim 16, wherein the adhesive force is at least 15 N/cm.

19. The multilayer article of claim 16, wherein the multilayer article is a hose comprising a tube comprising the cured elastomer surrounded by and bonded to the highly-fluorinated thermoplastic.

20. The multilayer article of claim 16, wherein the article is a hose comprising a tube comprising the highly-fluorinated thermoplastic surrounded by and bonded to the cured elastomer.
